(19) United States
(12) Patent Application Publication
(10) Pub. No.: US 2012/0246880 A1
(43) Pub. Date: Oct. 4, 2012

(54) CAP FOR WRITING MATERIAL, CLIP FOR WRITING MATERIAL, AND WRITING MATERIAL

(76) Inventors: Hiroshi Ootsuka, Yokohama-shi (JP); Yuusuke Nakamura, Yokohama-shi (JP)

(21) Appl. No.: 13/512,131

(22) PCT Filed: Dec. 1, 2010
(86) PCT No.: PCT/JP2010/071943

§ 371 Date: Jun. 7, 2012

(30) Foreign Application Priority Data
Dec. 1, 2009 (JP) 2009-273633
Dec. 1, 2009 (JP) 2009-273676
Dec. 1, 2009 (JP) 2009-273717

(51) Int. Cl. B43K 23/08; B43K 25/02

(52) U.S. Cl. 24/11 R

(57) ABSTRACT

A tubular shaped cap body for protecting a pen tip, which cap body includes an elastic member which is formed with an attachment hole in its side surface, and a clip member which is provided with a base part and a grip part which is provided at an outside surface of the base part. The clip member is provided with respect to the cap body so that the base part receives a front end of a writing instrument and the grip part extends through the attachment hole to the outside of the cap body.

### CROSS REFERENCE TO RELATED APPLICATIONS

This application relates to and claims priority from PCT/JP2010/071943 filed Dec. 12, 2010, the entire contents of which are incorporated herein by reference, and which in turn claims priority from JP2009-273676 filed Dec. 12, 2009, JP2009-273633 filed Dec. 12, 2009, and JP2009-273717 filed Dec. 12, 2009.

### TECHNICAL FIELD

The present invention relates to a writing instrument-use cap, a writing instrument-use clip, and a writing instrument.

### BACKGROUND ART

Known in the art is a writing instrument-use cap which, for the purpose of decoration, is formed by primary molding of an inside cap which is integrally provided with a clip and a housing and by two-color molding of an outside cap which covers the inside cap as a whole and has a total length which is longer than the inside cap (see Japanese Patent Publication (A) No. 11-342697).

Further, known in the art is a writing instrument-use grip of the shape of a cap of a writing instrument which is designed for enabling a writing instrument to be utilized as a means for input to a computer or electronic personal digital assistant, that is, a touch pen. It has a through hole at its front end part which allows the lead of a mechanical pencil to be extended or retracted, and is formed by a soft elastic material (see Japanese Patent Publication (A) No. 11-198585).

Furthermore, known in the art is a writing instrument-use cap which, for the purpose of reducing the number of parts and for decoration, has a cap body and a clip which is comprised of a clip support which is fastened to the cap body and a clip piece which is supported by the clip support (see Japanese Patent Publication (A) No. 2004-130681).

### SUMMARY OF INVENTION

According to the writing instrument-use cap of Japanese Patent Publication (A) No. 11-342697, two-color molding is used to form the writing instrument-use cap, but the effect is only to provide decorativeness. Therefore, in the same way as a conventional writing instrument-use cap, there is the problem that the cap surface is slippery and attachment to and detachment from the writing instrument body are difficult. Further, due to the surface being slippery, there is also the danger of slipping from the hand holding it or from a breast pocket etc. holding it.

The writing instrument-use grip of Japanese Patent Publication (A) No. 11-198585 is formed by an elastic material, so is structured to be less slippery compared with the writing instrument-use cap of Japanese Patent Publication (A) No. 11-342697. However, what is described in Japanese Patent Publication (A) No. 11-198585 is only a grip for enabling use of a mechanical pencil as a touch pen. The function as a cap is not considered. That is, the writing instrument-use grip of Japanese Patent Publication (A) No. 11-198585 is not provided with a clip for attachment to a document, clothing or other article, or a rubber seal etc. for preventing evaporation of ink from the writing part at the front end of the writing instrument. Even if trying to attach a clip to this structure, since the grip body as a whole is formed of an elastic material, the strength of the attachment part becomes weak and therefore an article cannot be stably attached to. Furthermore, since the whole is formed by an elastic material, when vertically dropped etc. and force is received in the axial direction of the writing instrument, buckling occurs and the writing part at the front end of the writing instrument is liable to be damaged.

The writing instrument-use cap of Japanese Patent Publication (A) No. 2004-130681 is fit with the writing instrument body at only the fitting part which is provided at the inside wall of the cap body, so when lifting up the clip piece to attach the instrument to some article, sometimes the engagement is loosened. Furthermore, this writing instrument-use cap is not designed for provision of a rubber seal for preventing evaporation of ink from the writing part at the front end of the writing instrument.

Therefore, the present invention has as its object the provision of a writing instrument-use cap and writing instrument which are not slippery, by which strength is secured, and which can be stably attached by a clip to some article.

Further, the present invention has as its object the provision of a writing instrument-use clip and writing instrument by which the strength of the writing instrument-use cap combined which is secured and which can be stably attached by a clip to some article.

In the first aspect of the present invention, there is provided a writing instrument-use cap which is provided with a tubular shaped cap body for protecting a pen tip, which cap body is comprised of an elastic member which is formed with an attachment hole in its side surface, and a clip member which is provided with a base part and a grip part which is provided at an outside surface of the base part, wherein the clip member is provided with respect to the cap body so that the base part receives a front end of a writing instrument and the grip part extends through the attachment hole to the outside of the cap body.

That is, in the first aspect of the present invention, since the cap body is comprised of an elastic member, it is structured to not become slippery. On the other hand, the problem that by making the cap body an elastic member, the strength falls and attachment of the clip itself becomes unstable, so the force of attachment to an article becomes weak is eliminated by the clip member being provided with a base part to thereby reinforce the cap body. Therefore, the writing instrument-use cap according to the present invention exhibits the effects of being non-slippery and being secured in strength and being able to be stably attached by the clip to some article.

In a second aspect of the present invention, there is provided a writing instrument-use cap wherein the base part is formed in a ring shape. That is, in the second aspect of the present invention, by the base part being a ring shape, the writing instrument-use cap is reinforced against load from all directions.

In a third aspect of the present invention, there is provided a writing instrument-use cap wherein an inside wall of the cap body toward the open end side from the base part in the longitudinal direction is provided with a stopping projection which fits with an engagement projection which is provided at the writing instrument body. That is, in the third aspect of the present invention, even with this writing instrument-use cap which has the novel constitution of a base part, it is possible to be fit with the writing instrument body.

In a fourth aspect of the present invention, there is provided a writing instrument-use cap wherein the base part is further provided with a back end face which abuts against a stopping face which is provided at the writing instrument body at the time of being fit together. That is, in the fourth aspect of the present invention, the writing instrument-use cap and writing instrument body can be positioned relative to each other in the longitudinal direction. Further, when fit together, the stopping face and the back end face abut against each other, so a fit with little looseness can be realized. Furthermore, when the cap is fit on, a sharp sound and clicking feeling are obtained, so the fit can be easily confirmed.

In a fifth aspect of the present invention, there is provided a writing instrument-use cap wherein an outer surface of the writing instrument-use cap is formed with at least one through hole which communicates with the inside. That is, in the fifth aspect of the present invention, when attaching the writing instrument-use cap to the writing instrument body and detaching the cap from the body, air can freely pass through the through hole. Therefore, there is no rise or fall in the inside pressure of the writing instrument-use cap and the writing instrument-use cap can be smoothly attached and detached. Further, even if the cap is mistakenly swallowed, the hole functions as an air hole, so inadvertent asphyxiation can be prevented.

In a sixth aspect of the present invention, there is provided a writing instrument-use cap which is further provided with a seal member which is held by an inner wall of a front end part of the cap body and which, when the writing instrument-use cap is attached over the writing instrument body, engages with a writing part at a front end of the writing instrument so as to seal the writing part. That is, in the sixth aspect of the present invention, when the writing instrument uses an ink with a high volatility, since the writing part is sealed, the evaporation of ink from the writing part can be prevented. Furthermore, the adhesion at the time of attachment of the seal member to the cap is high, so the seal member is resistant to detachment.

In a seventh aspect of the present invention, there is provided a writing instrument-use cap wherein a back end of the grip part is formed with a ball part, an outer circumference of the cap body is formed with a recess part which corresponds to the ball part, and the ball part and the recess part are arranged facing each other. That is, in the seventh aspect of the present invention, the ball part and recess part have corresponding shapes, so documents, clothing, or other articles attached to deform in similar shapes, so are hard to detach from and can be more firmly attached to.

In an eighth aspect of the present invention, there is provided a writing instrument-use cap wherein the cap body is injection molded using a mold which has a gate at a location other than one corresponding to the vicinity of the top part of the front end. That is, in the eighth aspect of the present invention, no gate mark is formed at the top part of the cap body, so the beauty is kept intact. Further, when using the top part as an erasing member of writing, there is no concern over scratching the paper surface etc.

In a ninth aspect of the present invention, there is provided a writing instrument-use cap which is provided with a tubular shaped cap body for protecting a pen tip, which cap body is comprised of an elastic member which is formed with an attachment hole in its side surface, and a clip member which is provided with a first base part and second base part, at least one bridge part which connects the first base part and the second base part, and a grip part which is provided at an outside surface of the first base part, wherein the clip member is provided with respect to the cap body so that the first base part and the second base part receive a front end of a writing instrument and the grip part extends through the attachment hole to the outside of the cap body.

That is, in the ninth aspect of the present invention, since the cap body is comprised of an elastic member, it is structured to not become slippery. On the other hand, the problem that by making the cap body an elastic member, the strength falls and attachment of the clip itself becomes unstable, so the force of attachment to an article becomes weak is eliminated by the clip member being provided with a first base part, second base part, and bridge parts thereby reinforcing the cap body. Therefore, the writing instrument-use cap according to the present invention exhibits the effects of being non-slippery and being secured in strength and being able to be stably attached by the clip to some article.

In a 10th aspect of the present invention, there is provided a writing instrument to which is attached any one of the caps of the first aspect to ninth aspect of the present invention.

In an 11th aspect of the present invention, there is provided a writing instrument-use clip which is suitable for forming a writing instrument-use cap which is provided with a tubular shaped cap body for protecting a pen tip, which cap body is comprised of an elastic member which is formed with an attachment hole in its side surface, which writing instrument-use clip is provided with a base part and a grip part which is provided at an outside surface of the base part and is provided at the cap body so that the base part is housed inside of the cap body and receives a front end of a writing instrument and the grip part extends through the attachment hole to the outside of the cap body.

That is, in the 11th aspect of the present invention, the base part of writing instrument-use clip is placed at the inside of the writing instrument-use cap to be combined with, so the effect is exhibited that the strength of the cap body is secured and the clip enables stable attachment to an article.

Below, the prevent invention will be able to be understood more sufficiently from the attached drawings and the description of preferred embodiments of the present invention.

### BRIEF DESCRIPTION OF DRAWINGS

FIG. 1 is a perspective view of a writing instrument-use cap.

FIG. 2 is a front view of the writing instrument-use cap.

FIG. 3 is a plan view of the writing instrument-use cap.

FIG. 4 is a bottom view of the writing instrument-use cap.

FIG. 5 is a right side view of the writing instrument-use cap.

FIG. 6 is a left side view of the writing instrument-use cap.

FIG. 7 is a cross-sectional view of the writing instrument-use cap.

FIG. 8 is a perspective view of a clip member of the writing instrument-use cap.

FIG. 9 is a right side view of the writing instrument-use cap to which a rubber seal is attached.

FIG. 10 is a cross-sectional view of the writing instrument-use cap to which a rubber seal is attached.

FIG. 11 is a perspective view of the writing instrument-use cap to the open end of which a hard ring is provided.

FIG. 12 is a cross-sectional view of the writing instrument-use cap to the open end of which a hard ring is provided.

FIG. 13 is a cross-sectional view of a writing instrument as a whole to which the writing instrument-use cap is attached.

FIG. 14 is a partial enlarged cross-sectional view of a front end of the writing instrument which is shown in FIG. 13.

FIG. 15 is a perspective view of a writing instrument-use cap according to another embodiment.

FIG. 16 is a front view of the writing instrument-use cap according to the other embodiment.

FIG. 17 is a plan view of the writing instrument-use cap according to the other embodiment.

FIG. 18 is a bottom view of the writing instrument-use cap according to the other embodiment.

FIG. 19 is a right side view of the writing instrument-use cap according to the other embodiment.

FIG. 20 is a right side view of the writing instrument-use cap according to the other embodiment to which a rubber seal is attached.

FIG. 21 is a left side view of the writing instrument-use cap according to the other embodiment.

FIG. 22 is a cross-sectional view of the writing instrument-use cap according to the other embodiment.

FIG. 23 is a perspective view of a clip member of the writing instrument-use cap according to the other embodiment.

FIG. 24 is a perspective view of the writing instrument-use cap with the second ring-shaped part stretched longer.

FIG. 25 is a cross-sectional view of the writing instrument-use cap with the second ring-shaped part stretched longer.

FIG. 26 is a perspective view of the clip member of the writing instrument-use cap with the second ring-shaped part stretched longer.

FIG. 27 is a cross-sectional view of a writing instrument as a whole to which the writing instrument-use cap according to the other embodiment is attached.

FIG. 28 is a perspective view of a writing instrument-use cap according to still another embodiment.

FIG. 29 is a cross-sectional view of the writing instrument-use cap which is shown in FIG. 28.

FIG. 30 is a perspective view of a clip member of the writing instrument-use cap which is shown in FIG. 28.

FIG. 31 is a cross-sectional view of a writing instrument as a whole to which the writing instrument-use cap which is shown in FIG. 28 is attached.

### DESCRIPTION OF EMBODIMENTS

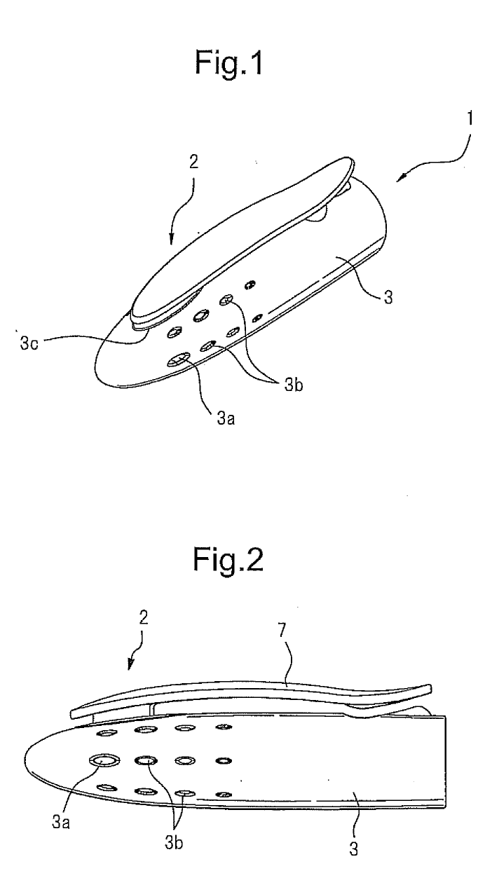

FIG. 1 is a perspective view of a writing instrument-use cap. Reference numeral 1 indicates a writing instrument-use cap as a whole, 2 a clip member, and 3 a cap body.

At the side surfaces of the cap body 3, two through holes 3a which are arranged symmetrically with respect to a center axial line of the writing instrument and which communicate through the clip member 2 to the inside of the writing instrument-use cap 1 are provided. By the cap body 3 being provided with the through holes 3a, at the time of attachment of the writing instrument-use cap 1 to the writing instrument body and detachment of the cap from the body, air inside of the writing instrument-use cap 1 can freely pass through the through holes 3a. For this reason, there is no rise or fall in pressure inside the writing instrument-use cap 1, so the writing instrument-use cap 1 can be smoothly attached and detached. Further, the two through holes 3a are arranged axially symmetrically, so the flow of air from the two holes can be made even and the cap can be attached and detached smoother than the case where the holes are not arranged axially symmetrically. Note that, in the present embodiment, there are two through holes, but there may also be one or three or more. They may be provided anywhere on the surface.

At side surfaces of the cap body 3, furthermore, for an aesthetic effect and prevention of slipping, the outer circumference is formed with a plurality of dimples 3b. Instead of the dimples, a pattern of grooves formed in a spiral shape around the outer circumference, a pattern of grooves formed in ring shapes across the outer circumference, a pattern of a plurality of grooves formed in straight shapes extending in the longitudinal direction, etc. may also be used.

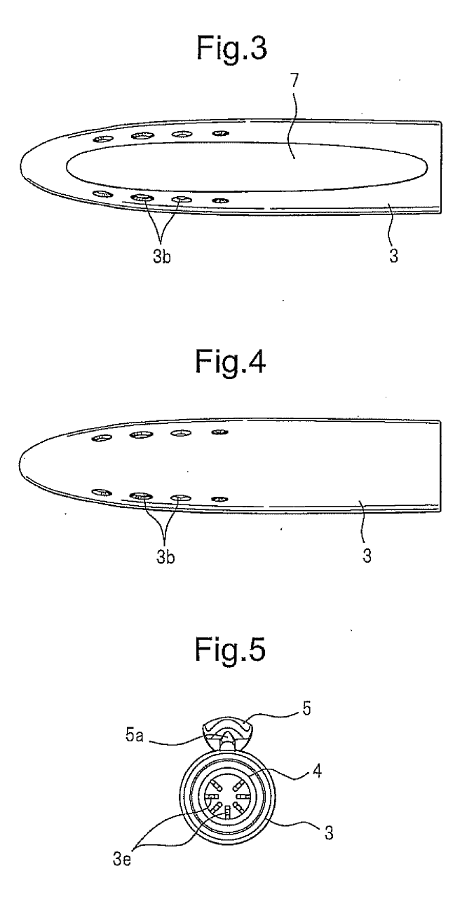

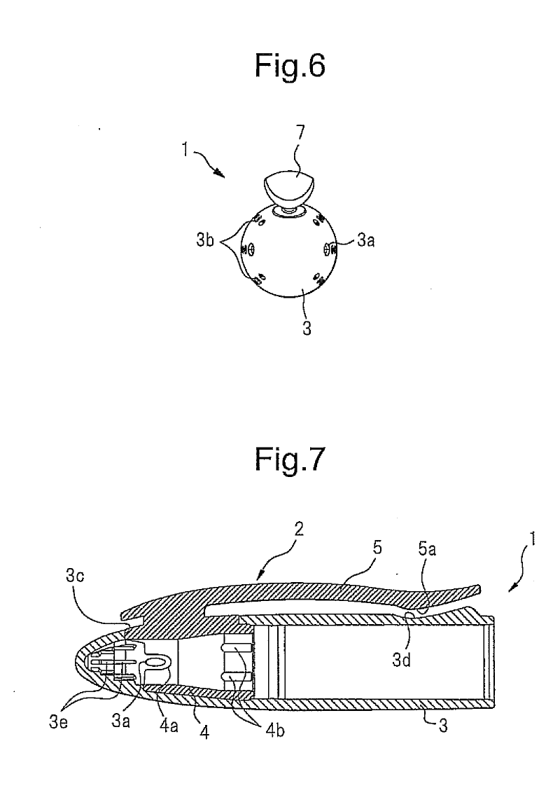

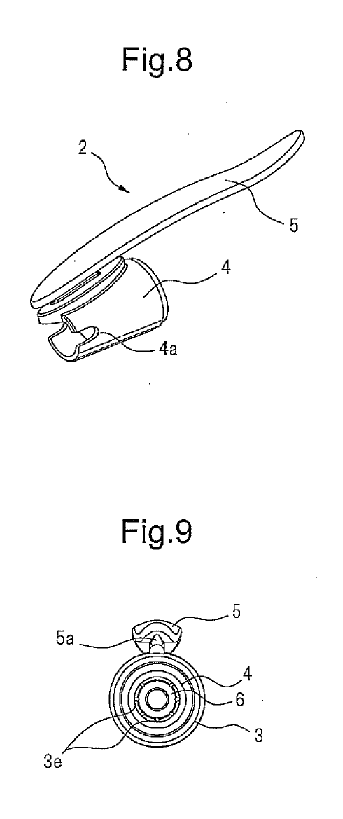

FIG. 2 is a front view of the writing instrument-use cap, FIG. 3 is a plan view of the same, FIG. 4 is a bottom view of the same, FIG. 5 is a right side view of the same, FIG. 6 is a left side view of the same, FIG. 7 is a cross-sectional view of the writing instrument-use cap 1, and FIG. 8 is a perspective view of a clip member of the writing instrument-use cap 1.

Note that, in the present Description, the closed end side of the writing instrument-use cap is defined as the “front end” or the “front side”, while the open end side of the writing instrument-use cap is defined as the “back end” or the “back side”.

While referring to FIG. 2 to FIG. 8, the clip member 2 will be explained. The clip member 2 is comprised of a base part 4 and a grip part 5 which is formed integrally with the outside surface of the base part 4. Note that, in the present embodiment, the base part 4 is formed into a ring shape and will be referred to below as the “ring-shaped part 4”.

The ring-shaped part 4 has a back side caliber which is larger than the front side caliber. In appearance, it forms a substantially tapered shape. It is formed so as to receive the front end of the writing instrument. The inside wall of the ring-shaped part 4 is formed into substantially cylindrical shapes by exactly predetermined lengths inward from the front end and from the back end. Between the regions which are formed by these cylindrical shapes, a tapered shape is formed. Further, the parts of the cap body 3 corresponding to the through holes 3a are formed with notched parts 4a shaped similar to the through holes so that the outside and inside of the writing instrument-use cap 1 are communicated. Furthermore, the inside wall part of the cylindrical shape at the back side is provided, at equal intervals, with a plurality of guide projections 4b which project out along the longitudinal direction toward the center axial line. The guide projections 4b will be explained later.

The grip part 5 is configured to have enough elasticity to be able to be attached to a document, clothing, or other article together with the cap body 3. The back end of the grip part 5 has a ball part 5a formed integrally with it.

As the material which forms the clip member 2, polycarbonate, acrylonitrile-butadiene-styrene, or other plastic may be mentioned. However, to prevent the grip part 5 from breaking when bent etc., it may also be formed using an elastic material, in particular an elastic material the same was the cap body which is shown below.

The cap body 3 is a tubular member with one end closed and comprised of an elastic member for protecting the pen tip of the writing instrument. It is formed with an attachment hole 3c at its side surface. Inside of the cap body 3, the ring-shaped part 4 of the clip member 2 is arranged. The grip part 5 of the clip member 2 is provided so as to extend through the attachment hole 3c to the outside of the cap body 3. That is, the cap body 3 closes the opening at the front side of the ring-shaped part 4 of the clip member 2 and extends in a tubular shape from the opening of the back side by exactly a predetermined length to form an opening in which the writing instrument body is to be inserted.

At the outer circumference of the cap body 3 which faces the ball part 5a of the clip member 2, a recess part 3d shaped corresponding to the ball part 5a may be formed. By the ball part 5a and the recess part 3d having corresponding shapes, documents, clothing, or other articles attached to deform in similar shapes, so can be more firmly attached to and become hard to detach from.

As the material which forms the cap body 3, silicone rubber, nitrile rubber, ethylene propylene rubber, ethylene propylene diene rubber, or another rubber material or a styrene-based elastomer, olefin-based elastomer, polyester-based elastomer, or other thermoplastic elastomer or other such elastic material, a mixture of two or more types of elastic materials, and a mixture of an elastic material and a plastic may be mentioned.

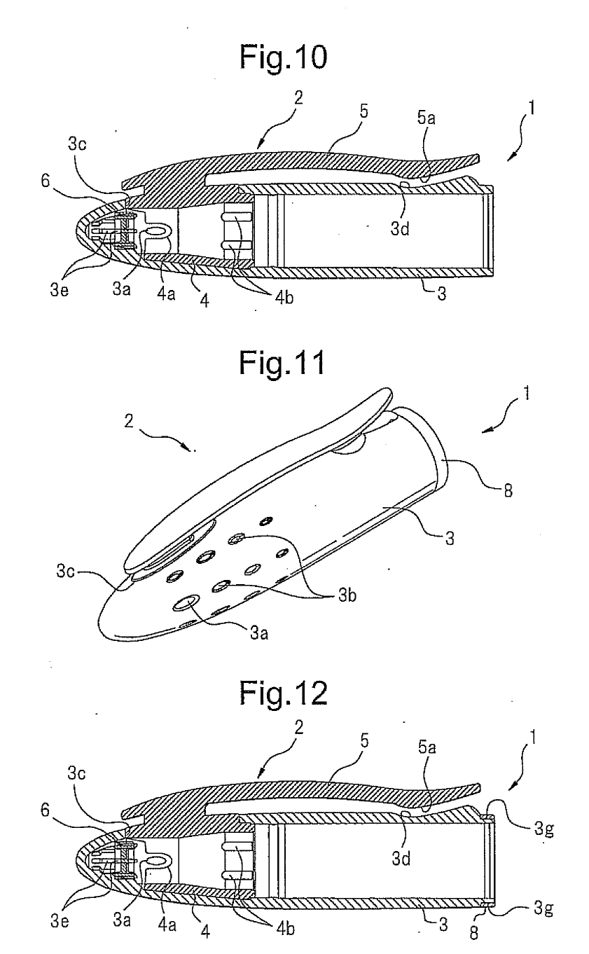

FIG. 9 is a right side view of a writing instrument-use cap 1 to which a rubber seal 6 is attached, while FIG. 10 is a cross-sectional view of a writing instrument-use cap 1 to which a rubber seal 6 is attached. The rubber seal 6 is arranged in the cap body 3 so as to prevent the evaporation of ink from the writing part of the front end of the writing instrument when the writing instrument at which the writing instrument-use cap 1 is used is a ball pen etc. using ink with a high volatility. FIG. 9 and FIG. 10 are similar to the views which are shown in FIG. 5 and FIG. 7 except for the point of the addition of the rubber seal 6.

The rubber seal 6 in the present embodiment 6 is comprised of an elastic member made of any elastic material. As shown in FIG. 10, it is an approximately disk shape which has circular recess parts which are coaxial at the two surfaces and has an H-shaped vertical cross-sectional shape. Note that, the rubber seal 6 may also be a spherical shape or other shape.

Referring to FIG. 7 and FIG. 10, at the inside wall of the front end of the cap body 3, a plurality of ribs 3e which extend across the longitudinal direction toward the center axial line are provided. These are structured to elastically deform and hold the rubber seal 6. The ribs 3e are arranged at equal intervals. Three or more are preferable.

If inserting the writing instrument body in the writing instrument-use cap 1 in the state where the rubber seal 6 is arranged inside the cap body 3, the writing part of the front end of the writing instrument engages with the rubber seal 6. That is, if the writing part presses against the center part of the rubber seal 6, the rubber seal 6 elastically deforms and the writing part is buried in the rubber seal 6. As a result, it becomes possible to prevent evaporation of the ink from the writing part.

Furthermore, in the process of production, when the rubber seal 6 is placed inside the cap body 3, since the cap body 3 is comprised of an elastic member, the cap body 3 also elastically deforms at the time of insertion of the rubber seal 6, so even if the dimensional tolerance of the rubber seal 6 is somewhat large, reliable placement becomes possible.

FIG. 11 is a perspective view of the writing instrument-use cap 1 to the open end of which a hard ring 8 is provided, while FIG. 12 is a cross-sectional view of the writing instrument-use cap 1 to the open end of which a hard ring 8 is provided. FIG. 11 and FIG. 12 are similar to the above-mentioned embodiment other that the open end of the writing instrument-use cap 1 is provided with the hard ring 8.

Here, “hard” means harder than the material which forms at least the cap body 3. As the material which forms the hard ring 8, a polycarbonate, glass, metal, etc. may be mentioned. Further, the same material as the material which forms the clip member 2 may also be used.

The hard ring 8 is a ring-shaped member which is formed into an approximately cylindrical shape and is fit over the outer circumference of the open end of the cap body 3. That is, the outer circumference of the cap body 3 is formed with a ring-shaped recess 3g for receiving the hard ring 8 stretching from the open end by a predetermined length so as to receive the hard ring 8. The inside diameter of the hard ring 8 is formed to be substantially the same as the outside diameter of the recess 3g part of the cap body 3 or slightly smaller than the same. The outside diameter of the hard ring 8 is formed to an outside diameter which is substantially the same as the vicinity of the open end of the cap body 3, therefore forms substantially the same outer circumference. In the state with the hard ring 8 fit over it, the back end face of the cap body 3 and the back end face of the hard ring 8 form substantially the same back end face.

Note that, the above-mentioned substantially cylindrical hard ring 8 had a rectangular cross-sectional shape in the diametrical direction so that the outer circumference and back end face form the same plane as the other parts of the cap body 3, but may be another cross-sectional shape, for example, a circular shape, elliptical shape, etc. as well.

The hard ring 8 is fit with the recess part 3g of the cap body 3 by press-fitting. When the cap body 3 does not have sufficient rigidity and the hard ring 8 is likely to detach, the two may also be bonded together by a binder. Further, the hard ring 8, as explained later, may be provided at the cap body 3 by two-color molding together with the clip member 2.

By providing the hard ring 8 at the open end of the writing instrument-use cap 1, bending of the open end is prevented, so the user can firmly hold the writing instrument-use cap 1. Further, by using a material different from the cap body 3, the open end has a different feel from the other parts of the cap body 3, so a decorative effect can be obtained.

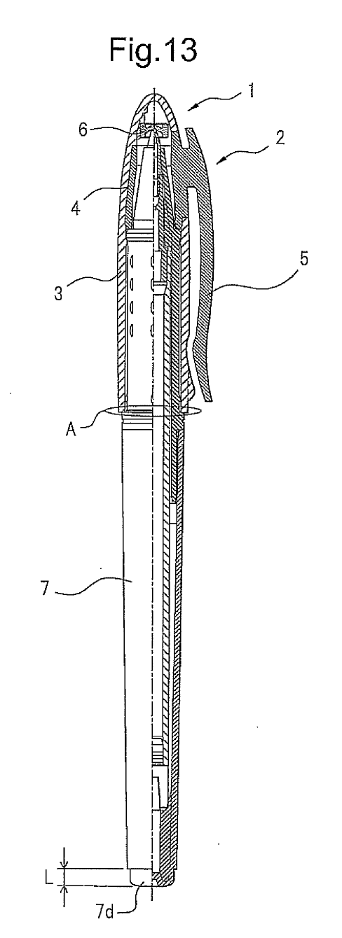

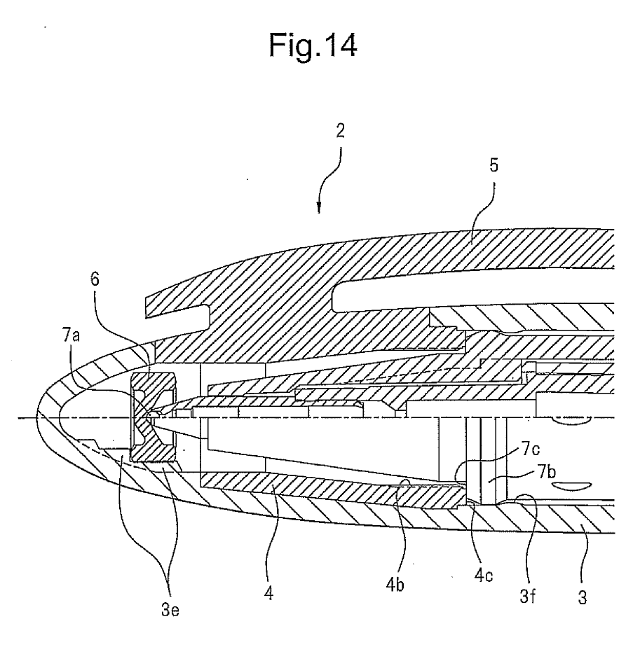

Next, while referring to FIG. 13 and FIG. 14, the operation for fitting the writing instrument-use cap 1 over the writing instrument body 7 will be explained. FIG. 13 is a cross-sectional view of the writing instrument as a whole to which the writing instrument-use cap 1 is attached, while FIG. 14 is a partial enlarged cross-sectional view of the front end of the writing instrument to which the writing instrument-use cap 1 is attached.

The writing instrument body 7 has the writing part 7a, an engagement projection 7b, and a stopping face 7c. The writing part 7a which is shown in FIG. 13 and FIG. 14 is the writing part 7a of a ball pen. The state is shown in which the rubber seal 6 is elastically deformed. The engagement projection 7b is a projection which is formed across the entire outer circumferential surface of the writing instrument body 7, while the stopping face 7c is a ring-shaped flat surface which is formed from the vicinity of the bottom of the engagement projection 7b at the writing part 7a side and is substantially vertical to the center axial line of the writing instrument. On the other hand, at the inside wall of the cap body 3 at the back side from the ring-shaped part 4 of the clip member 2, a stopping projection 3f which engages with the engagement projection 7b of the writing instrument body 7 is formed over the entire circumference.

If the writing instrument body 7 is inserted into the writing instrument-use cap 1 from the right direction toward the left direction in the figure, first the engagement projection 7b of the writing instrument body 7 abuts against the stopping projection 3f of the cap body 3 and stops. If further pushing in the writing instrument body 7 from that state, the engagement projection 7b of the writing instrument body 7 and the stopping projection 3f of the cap body 3 push against each other and a reaction force is caused at the two in a direction vertical to the center axial line. As a result, elastic deformation occurs in one or both of the direction of contraction of the writing instrument body 7 and direction of expansion of the cap body 3, and the engagement projection 7b of the writing instrument body 7 disengages from the stopping projection 3f of the cap body 3 and passes to the inside of the cap body 3. After the engagement projection 7b of the writing instrument body 7 passes the stopping projection 3f of the cap body 3, the stopping face 7c of the writing instrument body 7 abuts against the back end face 4c of the ring-shaped part 4 of the clip member 2 and stops whereby the operation for fitting together the writing instrument-use cap 1 and the writing instrument body 7 is completed as in the state which is shown in FIG. 13 and FIG. 14.

When finishing being fit together, the direction for pushing the writing instrument body 7 into the cap body 3 is restricted by the engagement of the stopping face 7c of the writing instrument body 7 and the back end face 4c of the ring-shaped part 4, while the direction for detaching the writing instrument body 7 from the cap body 3 is restricted by the engagement of the engagement projection 7b of the writing instrument body 7 and the stopping projection 3f of the cap body 3 in the opposite direction from the above-mentioned push-in direction.

When detaching the writing instrument-use cap 1 from the writing instrument body 7, by pulling the writing instrument body 7 opposite to the attachment of the writing instrument-use cap 1 to the writing instrument body as explained above, a reaction force is generated at both in the vertical direction to the center axial line. Due to elastic deformation which occurs as a result of this, the engagement projection 7b of the writing instrument body 7 and the stopping projection 3f of the cap body 3 disengage and the writing instrument-use cap 1 can be detached from the writing instrument body 7.

When being fit together, the stopping face 7c of the writing instrument body 7 and the back end face 4c of the ring-shaped part 4 abut or become in close proximity, whereby the force which is applied to the writing instrument-use cap 1 itself when lifting up the grip part 5 for attachment to an article is absorbed by the ring-shaped part 4 and the abutting face between the stopping face 7c and the back end face 4c. Therefore, the cap body 3 is kept from greatly deforming and from moving greatly with respect to writing instrument body 7. The engagement of the writing part 7a of the front end of the writing instrument and the rubber seal 6 is maintained without detachment.

The engagement projection 7b of the writing instrument body 7 and the stopping projection 3f of the cap body 3 are respectively formed across the entire circumference of the outer circumference of the writing instrument body 7 and the entire circumference of the inside wall of the cap body 3, but they may also be respectively formed at just parts of the same.

The position of the back end face 4c of the ring-shaped part 4 with respect to the cap body 3, the shape and position of the stopping projection 3f of the cap body 3, and the shape of the engagement projection 7b of the writing instrument body 7 may be adjusted to realize a more secure fit with little looseness (play). The position of the stopping projection 3f is desirably a position which is close to the back end face 4c. Furthermore, since there is less looseness, the writing part 7a reliably fits with the rubber seal 6, and evaporation of ink due to a poor seal of the writing part 7a can be prevented. Furthermore, to prevent the above-mentioned fit and the engagement between the writing part 7a and the rubber seal 6 from being impaired, the back end face of the cap body 3 and the part of the writing instrument body 7 which engages with the back end face are configured with a clearance between them (see FIG. 13, part A).

The length of the ring-shaped part 4 of the clip member 2 in the longitudinal direction can be set in various ways, but the shorter the part, the worse the stability of the grip part 5 becomes since the cap body 3 is an elastic member. Therefore, the length of the ring-shaped part 4 in the longitudinal direction is determined so that the stability of the grip part 5 becomes within the allowable range. Further, the back end face 4c of the ring-shaped part 4 is preferably determined so as not to exceed the back end face of the cap body 3.

When inserting the writing instrument body 7 into the writing instrument-use cap 1, it is preferably inserted straight so that the center axial line of the writing instrument-use cap 1 matches the center axial line of the writing instrument body 7. However, sometimes the writing instrument body 7 is not inserted straight into the writing instrument-use cap 1, but is inserted in a state where the two center axial lines are slanted from each other. For this reason, sometimes the two cannot be fit together well.

Therefore, as explained above, the ring-shaped part 4 of the clip member 2 is provided with guide projections 4b. Even if the writing instrument body 7 is inserted into the writing instrument-use cap 1 by a slant, it is guided to a state where the center axial lines of the two match when they finally finish being fit together. That is, by the ring-shaped part 4 of the clip member 2 being provided with the guide projections 4b, the substantive inside diameter of the ring-shaped part 4 of the clip member 2 passing through the vertex parts of the guide projections 4b becomes smaller than the inside diameter of a usual cap which does not have guide projections 4b. For this reason, there is less looseness (play) between the ring-shaped part 4 and the writing instrument body 7 and the angle which the two center axial lines can form at the time of insertion of the writing instrument body 7 becomes smaller. Therefore, when the writing instrument body 7 is inserted at a slant, the frictional resistance between the guide projections 4b of the ring-shaped part 4 and the outer circumference of the abutting writing instrument body 7 becomes smaller and the parts can be smoothly fit together.

Further, by having the guide projections 4b, the contact area with the outer circumference of the writing instrument body 7 also becomes smaller. Therefore, the frictional resistance also becomes smaller. Note that, the guide projections 4b may have other shapes as well. The shapes and longitudinal direction lengths are optimized so that the guide projections 4b and the front part of the writing instrument body 7 do not contact or do not engage and thereby poor fit does not occur even if the writing instrument body 7 has been inserted at a slant.

The guide projections 4b are also useful for centering the writing instrument body 7 with respect to the writing instrument-use cap 1. That is, by having the guide projections 4b, as explained above, there is less looseness between the ring-shaped part 4 and the writing instrument body 7 and accurate centering becomes possible. Further, the writing instrument body 7 is mainly centered by the guide projections 4b which are provided at the ring-shaped part 4 of the clip member 2, so centering becomes possible without regard as to the total length of the writing instrument-use cap 1.

Furthermore, the guide projections 4b provide a stable fit when, for example, attaching the writing instrument-use cap 1 to the back end 7d of the writing instrument body 7 at the time of writing. That is, the writing instrument-use cap 1 is fit to the writing part 7a side of the above-mentioned writing instrument body 7 by a snap-type fit, while the writing instrument-use cap 1 is fit to the back end 7d of the writing instrument body 7 by press-fitting. Therefore, by optimally designing, in addition to the relationship between the inside diameter of the ring-shaped part 4 of the clip member 2 passing through the vertex parts of the guide projections 4b and the outside diameter of the back end 7d of the writing instrument body 7, the length of the press-fitting distance L in FIG. 13, it becomes possible to obtain the desired fitting force. As one indicator for setting the fitting force, the stability when, in the state with the writing instrument-use cap 1 fit over the back end 7d of the writing instrument body 7, as explained later, using the top part etc. of the cap body 3 as an erasing member of writing and rubbing the paper surface etc. may be mentioned.

The writing instrument-use cap 1, for example, can be fabricated by two-color molding. When using two-color molding, first, the clip member 2 is molded by the primary molding, then the cap body 3 is molded by the secondary molding whereby the writing instrument-use cap is formed.

Two-color molding usually uses molds for primary molding use and secondary molding use and a core pin to form the writing instrument-use cap around the front end of the core pin. When, at the time of injection molding, the core pin is only held at one end, the core pin is sometimes bent etc. making it impossible for it to be molded into the accurate dimensions and shape. That is, at the time of injection molding, the front end part of the core pin is usually not fastened. The core pin is held only by the other end.

Therefore, at the time of injection molding, a fastening pin which sticks out from the mold to the inside of the cavity abuts against and supports the front end of the core pin, whereby the front end part of the core pin is fastened and bending of the core pin at the time of injection molding is prevented. Note that, even during the injection molding, the fastening pin abuts against the front end of the core pin, so the molded article has a cavity in the shape of the fastening pin. By utilizing this and selecting the horizontal cross-sectional shape of the fastening pin, it is possible to form the notched parts 4a of the clip member 2 by the primary molding and form the through holes 3a of the cap body 3 in the secondary molding. Note that, the fastening pin is provided at the core pin side.

The cap body 3, which accounts for the majority of the surface of the writing instrument-use cap 1, is comprised of an elastic material, so the writing instrument-use cap 1 and writing instrument which is attached to the same are resistant to slipping. Further, the clip member 2 has the ring-shaped part 4, so the part which load is particularly applied at the time of an operation for attachment is reinforced, therefore it is possible secure strength and possible to be stably attached to an article. Therefore, there is the advantage that there is less danger of dropping from the hand which holds the writing instrument or a breast pocket etc. holding the same compared with a conventional writing instrument. Note that, in the present embodiment, the base part 4 was formed into a ring shape, but it may be any shape enabling the cap body to be reinforced, for example, a shape having a C-shaped horizontal cross-section.

Further, for example, while an operation which is usually performed by the user, even when the palm, the middle finger, the ring finger, and the little finger are used to grip the writing instrument body and the index finger and the thumb are used to attach and detach the writing instrument-use cap, there is the advantage of resistance to slipping and the ability to be easily attached and detached. Furthermore, for example, in a ball pen etc., which is susceptible to vibration or impact, when the writing instrument is dropped vertically from the top part of the cap, the impact on the writing instrument body is eased by the writing instrument-use cap which is comprised of the elastic member and the strength is secured by the clip member 2. Due to this, there is also the advantage that the danger of leakage of fluid from the writing part or other problems occurring is also reduced.

Furthermore, the majority of the writing instrument-use cap is covered by an elastic member, so by using any part which is covered by the elastic member for rubbing, use as an erasing member which erases writing by the writing instrument is possible. For example, it is possible to use the writing instrument-use cap for erasing writing by the pencil. Further, when used for a writing instrument which has ink which changes color due to heat, the paper surface may be rubbed to generate heat of friction and change the color of the writing on the paper surface. Note that, the cap surface preferably has a surface roughness Ra of 0.009 μm to 0.014 μm. If smoother than 0.009 μm, the cap is liable to slip on the paper surface, while if 0.014 μm or more, the paper surface is liable to be unintentionally scratched. Further, by making the durometer hardness as defined by JIS K6253 D 35 to 90, it is possible to improve the rigidity of the cap as a whole while facilitating the generate of the heat of friction without scratching the paper surface.

Note that, when using the part which is covered by an elastic member as an erasing member, the erasing member is not fit at the end at the opposite side to the writing part of the writing instrument body as usually seen in a pencil with an eraser etc., so there is also the advantage that detachment of the erasing member and other trouble do not occur.

Further, in injection molding of the cap body 3, the entry point into the inside of the cavity of the mold, that is, the gate part, is placed not at the top part of the cap body 3, but at a side surface, for example, a position where even if the cap body is inclined by 45°, it will not abut against the writing surface or the paper surface, so it is possible to make the surface of the top part smooth in appearance. Further, when using the top apart as an erasing member, use becomes possible without the problem of a so-called gate mark scratching the paper surface.

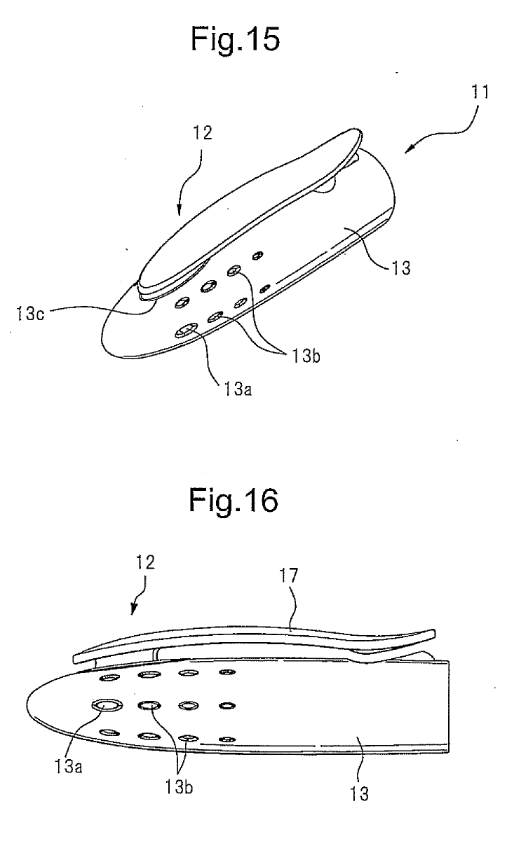

FIG. 15 is a perspective view of the writing instrument-use cap according to another embodiment. Reference numeral 11 shows the writing instrument-use cap as a whole, 12 the clip member, and 13 the cap body.

At the side surfaces of the cap body 13, two through holes 13a which are arranged symmetrically with respect to the center axial line of the writing instrument and which communicate through the clip member 12 to the inside of the writing instrument-use cap 11 are provided. By the cap body 13 being provided with the through holes 13a, when attaching or detaching the writing instrument-use cap 11 to or from the writing instrument body, it becomes possible for the air inside of the writing instrument-use cap 11 to freely pass through the through holes 13a. For this reason, it becomes possible for the writing instrument-use cap 11 to be smoothly attached and detached without the pressure inside of the writing instrument-use cap 11 rising or falling. Further, by the two through holes 13a being arranged axially symmetrically, air passes through the two holes evenly and smooth attachment and detachment becomes possible compared with holes not being arranged axially symmetrically. Note that, in the present embodiment, there are two through holes, but there may also be one or three or more. They may be provided anywhere on the outside surface.

The side surfaces of the cap body 13 are formed at the outer circumference with a plurality of dimples 13b for a further aesthetic effect and prevention of slip. Instead of the dimples, a pattern of grooves formed in a spiral shape around the outer circumference, a pattern of grooves formed in ring shapes across the outer circumference, a pattern of a plurality of grooves formed in straight shapes extending in the longitudinal direction, etc. may also be used.

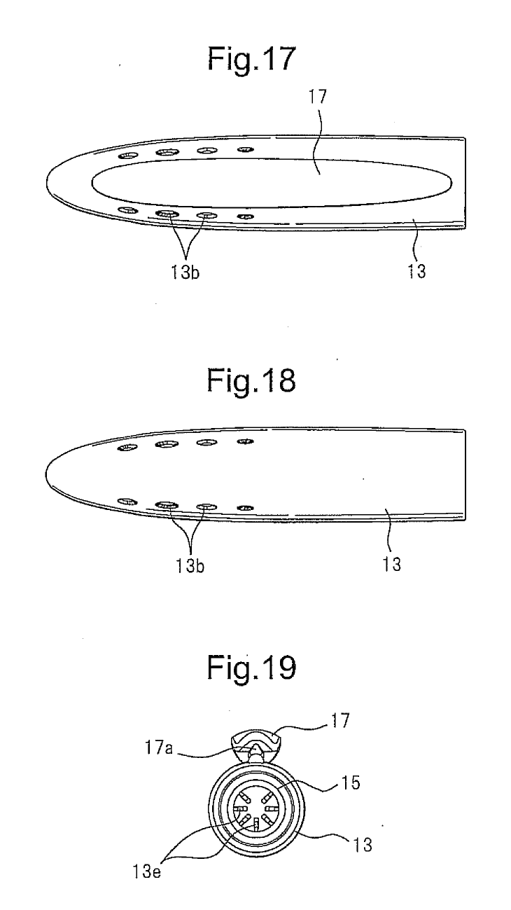

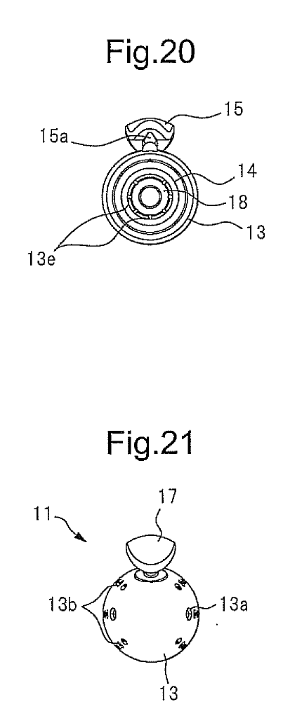

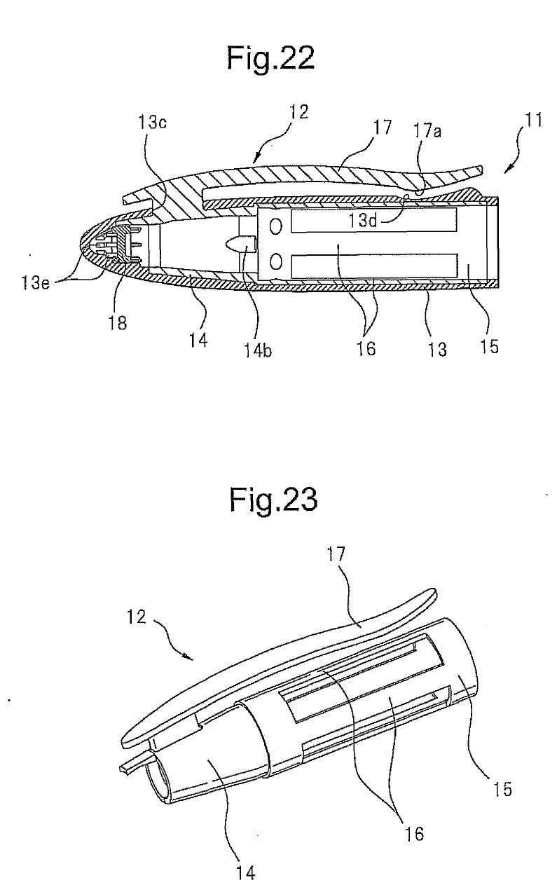

FIG. 16 is a front view of the writing instrument-use cap 11 according to the other embodiment, FIG. 17 is a plan view of the same, FIG. 18 a bottom view of the same, FIG. 19 a right side view of the same, FIG. 20 a right side view of the writing instrument-use cap 11 to which the rubber seal 18 is attached, FIG. 21 a left side view of the writing instrument-use cap 11 according to the other embodiment, FIG. 22 a cross-sectional view of the writing instrument-use cap 11 according to the other embodiment, and FIG. 23 is a perspective view of the writing instrument-use cap 11 according to the other embodiment.

While referring to FIG. 16 to FIG. 23, the clip member 12 will be explained. The clip member 12 is comprised of a first base part 14, a second base part 15, a plurality of bridge parts 16 which couple the first base part 14 and the second base part 15, and a grip part 17 which is integrally formed at the outer circumference of the first base part 14. Note that, in the present embodiment, the first base part 14 and the second base part 15 are formed in ring shapes. Below, these will be called the “first ring-shaped part 14” and the “second ring-shaped part 15”.

The first ring-shaped part 14 has a back side caliber which is larger than the front side caliber. In appearance, it forms a substantially tapered shape. It is formed so as to receive the writing instrument body. The inside wall of the first ring-shaped part 14 is formed into substantially cylindrical shapes by exactly predetermined lengths inward from the front end and from the back end. Between the regions which are formed by these cylindrical shapes, a tapered shape is formed. Further, the parts of the cap body 13 corresponding to the through hole are formed with notched parts (not shown) shaped similar to the through holes so that the outside and inside of the writing instrument-use cap 11 are communicated. Furthermore, the inside wall part of the cylindrical shape at the back side is provided, at equal intervals, with a plurality of guide projections 14b which project out along the longitudinal direction toward the center axial line. The guide projections 14b will be explained later.

The second ring-shaped part 15 is formed into a substantially cylindrical shape which has an inside diameter and an outside diameter which are substantially equal to the cylindrical shape of the back end side of the first ring-shaped part 14. Together with the plurality of bridge parts 16 which connect the first ring-shaped part 14 and the second ring-shaped part 15, it reinforces the cap body 13 at the back end side from the first ring-shaped part 14.

At least one bridge part 16 is provided. In the present embodiment, it is rectangular in shape, but it may also be elliptical in shape or another shape as well. By providing the bridge parts 16, it is possible to reinforce the corresponding part of the cap body 13 and possible to save on the material of the clip member 12 between the bridge parts 16 and lighten the weight of the clip member 12.

The grip part 17 is designed to have an elasticity enabling a document, clothing, or other article to be gripped with the cap body 13. At the back end of the grip part 17, a ball part 17a is integrally formed.

As the material which forms the clip member 12, a polycarbonate, acrylonitrile-butadiene-styrene or other plastic may be mentioned. However, to prevent breakage at the time of bending the grip part 17 etc., it may also be formed using an elastic material, in particular, the same elastic material as the cap body shown below.

The cap body 13 is a tubular member which is closed at one end and is comprised of an elastic member so as to protect a pen tip of a writing instrument and is formed with an attachment hole 13c at its side surface. Inside the cap body 13, a first ring-shaped part 14 and a second ring-shaped part 15 and bridge parts 16 of the clip member 12 are arranged. The grip part 17 of the clip member 12 is provided to extend through the attachment hole 13c to the outside of the cap body 13. That is, the cap body 13 closes the opening at the front side of the first ring-shaped part 14 of the clip member 12 and extends in a tubular shape over the second ring-shaped part 15 in the longitudinal direction at the back side by exactly a predetermined length to form an opening in which the writing instrument body is to be inserted.

At the outer circumference of the cap body 13 which faces the ball part 17a of the clip member 12, a recess part 13d shaped corresponding to the ball part 17a may be formed. By the ball part 17a and the recess part 13d having corresponding shapes, documents, clothing, or other articles attached to deform in similar shapes, so can be more firmly attached to and become hard to detach from. Furthermore, the back end of the second ring-shaped part 15 is gripped more firmly even if forming the clip member 12 so as to extend over the recess part 13d in the longitudinal direction at the back end side.

As the material which forms the cap body 13, silicone rubber, nitrile rubber, ethylene propylene rubber, ethylene propylene diene rubber, or another rubber material or a styrene-based elastomer, olefin-based elastomer, polyester-based elastomer, or another thermoplastic elastomer or other such elastic material, a mixture of two or more elastic materials, or a mixture of an elastic material and a plastic may be mentioned.

The writing instrument-use cap 11 of the present embodiment is a ball pen etc. using ink with a high volatility, so to prevent evaporation of the ink from the writing part of the front end of the writing instrument, a rubber seal 18 is placed inside of the cap body 13.

The rubber seal 18 in the present embodiment is comprised of an elastic member made of any elastic material. As shown in FIG. 22, it is an approximately disk shape which has circular recess parts which are coaxial at the two surfaces and has an H-shaped vertical cross-sectional shape. Note that, the rubber seal 18 may also be a spherical shape or other shape.

If referring to FIG. 22, at the inside wall of the front end of the cap body 13, a plurality of ribs 13e which extend across the longitudinal direction toward the center axial line are provided. These are structured to elastically deform and hold the rubber seal 18. The ribs 13e are arranged at equal intervals. Three or more are preferable.

If inserting the writing instrument body in the writing instrument-use cap 11 in the state where the rubber seal 18 is arranged inside the cap body 3, the writing part of the front end of the writing instrument engages with the rubber seal 18. That is, if the writing part presses against the center part of the rubber seal 18, the rubber seal 18 elastically deforms and the writing part is buried in the rubber seal 18. As a result, it becomes possible to prevent evaporation of the ink from the writing part.

Furthermore, in the process of production, when the rubber seal 18 is placed inside the cap body 13, since the cap body 13 is comprised of an elastic member, the cap body 13 also elastically deforms at the time of insertion of the rubber seal 18, so even if the dimensional tolerance of the rubber seal 18 is somewhat large, reliable placement becomes possible.

Note that, in the case of the writing instrument where there is no need to prevent evaporation of the ink, the writing instrument-use cap need not have the rubber seal 18 and the ribs 13e.

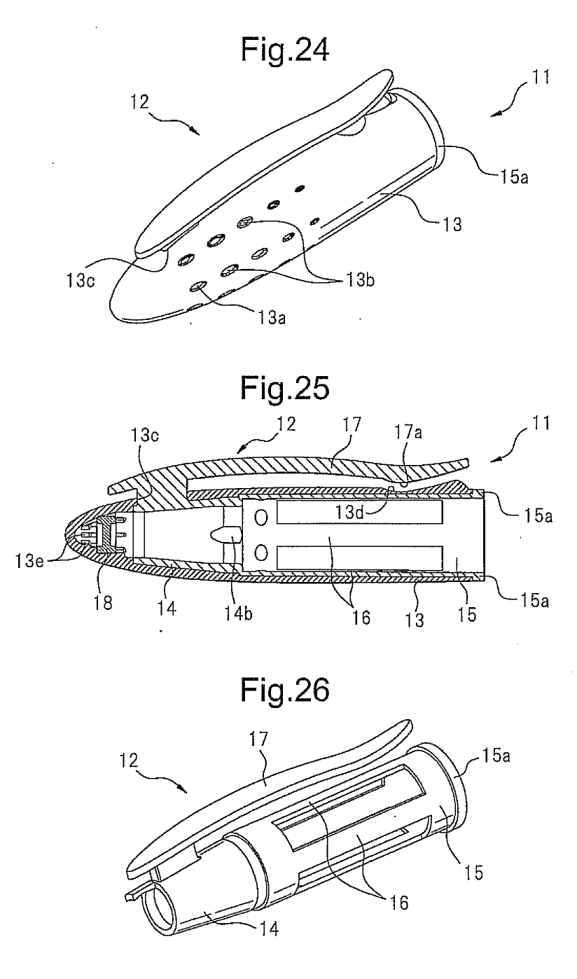

FIG. 24 is a perspective view of the writing instrument-use cap 11 with the second ring-shaped part 15 stretched longer, FIG. 25 is a cross-sectional view of the writing instrument-use cap 11 with the second ring-shaped part 15 stretched longer, and FIG. 26 is a perspective view of the clip member 12 of the writing instrument-use cap with the second ring-shaped part 15 stretched longer. FIG. 24 to FIG. 26 are similar to the above-mentioned embodiment except for the point of stretching the second ring-shaped part 15 of the writing instrument-use cap 11.

In the writing instrument-use cap 11 which is shown in FIG. 24 to FIG. 26, the second ring-shaped part 15 of the clip member 12 is stretched in the longitudinal direction to the back end side and the back end is formed with a projecting part which sticks outward in the diametrical direction, that is, a flange part 15a. By forming the total length of the cap body 13 shorter by exactly the amount of the flange part 15a, the total length of the writing instrument-use cap 11 does not change from the above-mentioned embodiment. The outer circumference of the flange part 15a is formed so as to form the same plane with the outer circumference of the cap body 13 near the flange part 15a.

Note that, the above-mentioned flange part 15a had an outer circumference with a rectangular cross-sectional shape in the diametrical direction so as to form the same plane with the other parts of the cap body 13, but may also be other cross-sectional shapes, for example, shapes having arcs or shapes which have parts of polyhedrons.

By stretching the second ring-shaped part 15 of the writing instrument-use cap 11 in the longitudinal direction to the back end side compared with the cap body 13, the open end of the writing instrument-use cap 11 is reinforced and bending of the open end is prevented, so the user can firmly hold the writing instrument-use cap 11. Further, by using a material which is different from the cap body 13, a decorative effect is obtained since the open end has a different feeling from the other parts of the cap body 13.

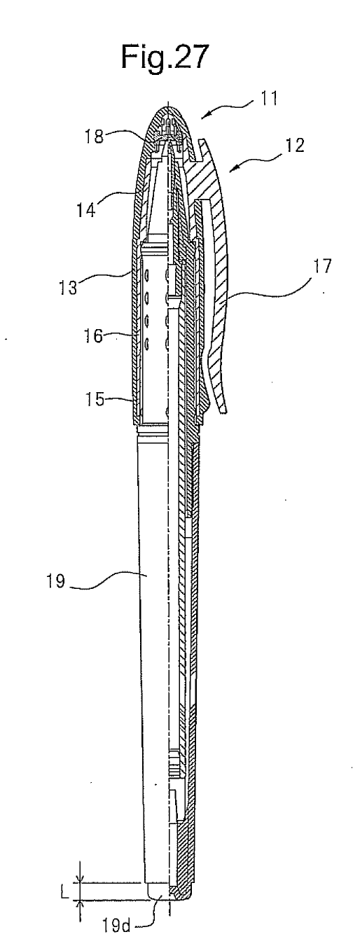

FIG. 27 is a cross-sectional view of a writing instrument as a whole to which the writing instrument-use cap is attached. When inserting the writing instrument body 19 into the writing instrument-use cap 11, it is desirably inserted straight so that the center axial line of the writing instrument-use cap 11 and the center axial line of the writing instrument body 19 match. However, sometimes, the writing instrument body 19 is not inserted straight into the writing instrument-use cap 11, but is inserted in a state with the two center axial lines at a slant. For this reason, sometimes the two cannot be fit together well.

Therefore, as explained above, the ring-shaped part 14 of the clip member 12 is provided with guide projections 14b. Even if the writing instrument body 19 is inserted into the writing instrument-use cap 11 by a slant, it is guided to a state where the center axial lines of the two match when they finally finish being fit together. That is, by the ring-shaped part 14 of the clip member 12 being provided with the guide projections 41b, the substantive inside diameter of the first ring-shaped part 14 of the clip member 12 passing through the vertex parts of the guide projections 14b becomes smaller than the inside diameter of a usual cap which does not have guide projections 14b. For this reason, there is less looseness (play) between the first ring-shaped part 14 and the writing instrument body 19 and the angle which the two center axial lines can form at the time of insertion of the writing instrument body 19 becomes smaller. Therefore, when the writing instrument body 19 is inserted at a slant, the frictional resistance between the guide projections 14b of the first ring-shaped part 14 and the outer circumference of the abutting writing instrument body 19 becomes smaller and the parts can be smoothly fit together.

Further, by having the guide projections 14b, the contact area with the outer circumference of the writing instrument body 19 also becomes smaller. Therefore, the frictional resistance also becomes smaller. Note that, the guide projections 14b may have other shapes as well. The shapes and longitudinal direction lengths are optimized by experiments so that poor fit does not occur even if the writing instrument body 19 has been inserted at a slant.

Note that, regarding the fit of the writing instrument-use cap 11 with the writing instrument body 19 in the present embodiment, the conventional known fitting structure may be formed at the inner wall of the cap body at the back end side from the second ring-shaped part 15 clip member 12 in the longitudinal direction or at the inner wall of the second ring-shaped part 15 of the clip member 12.

The guide projections 14b are also useful for centering the writing instrument body 19 with respect to the writing instrument-use cap 11. That is, by having the guide projections 14b, as explained above, there is less looseness between the first ring-shaped part 14 and the writing instrument body 19 and accurate centering becomes possible. Further, the writing instrument body 19 is mainly centered by the guide projections 14b which are provided at the first ring-shaped part 14 of the clip member 12, so centering becomes possible without regard as to the total length of the writing instrument-use cap 11.

Furthermore, the guide projections 14b provide a stable fit by press-fitting when, for example, attaching the writing instrument-use cap 11 to the back end 19d of the writing instrument body 19 at the time of writing. By optimally designing, in addition to the relationship between the inside diameter of the first ring-shaped part 14 of the clip member 12 passing through the vertex parts of the guide projections 14b and the outside diameter of the back end 19d of the writing instrument body 19, the length of the press-fitting distance L in FIG. 27, it becomes possible to obtain the desired fitting force. As one indicator for setting the fitting force, the stability when, in the state with the writing instrument-use cap 11 fit over the back end 19d of the writing instrument body 19, as explained later, using the top part etc. of the cap body 13 as an erasing member of writing and rubbing the paper surface etc. may be mentioned.

The writing instrument-use cap 11, for example, can be fabricated by two-color molding. When using two-color molding, first, the clip member 12 is molded by the primary molding, then the cap body 13 is molded by the secondary molding whereby the writing instrument-use cap is formed.

Two-color molding usually uses molds for primary molding use and secondary molding use and a core pin to form the writing instrument-use cap around the front end of the core pin. When, at the time of injection molding, the core pin is only held at one end, the core pin is sometimes bent etc. making it impossible for it to be molded into the accurate dimensions and shape. That is, at the time of injection molding, the front end part of the core pin is usually not fastened. The core pin is held only by the other end.

Therefore, at the time of injection molding, a fastening pin which sticks out from the mold to the inside of the cavity abuts against and supports the front end of the core pin, whereby the front end part of the core pin is fastened and bending of the core pin at the time of injection molding is prevented. Note that, even during the injection molding, the fastening pin abuts against the front end of the core pin, so molded article has a cavity in the shape of the fastening pin. By utilizing this and selecting the horizontal cross-sectional shape of the fastening pin, it is possible to form the notched parts 14a of the clip member 2 by the primary molding and form the through holes 13a of the cap body 13 in the secondary molding. Note that, the fastening pin is provided at the core pin side.

The cap body 13, which accounts for the majority of the surface of the writing instrument-use cap 11, is comprised of an elastic material, so the writing instrument-use cap 11 and writing instrument which is attached to the same are resistant to slipping. Further, the clip member 12 has the first ring-shaped part 14, the second ring-shaped part 15, and the bridge parts 16, so the parts at which load is particularly applied at the time of an operation for attachment are reinforced, therefore it is possible secure strength and possible to be stably attached to an article. Therefore, there is the advantage that there is less danger of dropping from the hand which holds the writing instrument or a breast pocket etc. holding the same compared with a conventional writing instrument.

In the present embodiment, the first base part 14 and first base part 15 were formed into ring shapes, but they may be any shapes enabling the cap body to be reinforced, for example, shapes having a C-shaped horizontal cross-section. Further, in the present embodiment, there were two base parts, but there may also be three or more. In this case, these base parts are connected by at least one bridge part.

Further, for example, while an operation which is usually performed by the user, even when the palm, the middle finger, the ring finger, and the little finger are used to grip the writing instrument body and the index finger and the thumb are used to attach and detach the writing instrument-use cap, there is the advantage of resistance to slipping and the ability to be easily attached and detached. Furthermore, for example, in a ball pen etc., which is susceptible to vibration or impact, when the writing instrument is dropped vertically from the top part of the cap, the impact on the writing instrument body is eased by the writing instrument-use cap which is comprised of the elastomer and the strength is secured by the clip member 12. Due to this, there is also the advantage that the danger of leakage of fluid from the writing part or other problems occurring is also reduced.

Furthermore, the majority of the writing instrument-use cap is covered by an elastic member, so by using any part which is covered by the elastic member for rubbing, use as an erasing member which erases writing by the writing instrument is possible. For example, it is possible to use the writing instrument-use cap for erasing writing by a pencil. Further, when used for a writing instrument which has ink which changes color due to heat, the paper surface may be rubbed to generate heat of friction and change the color of the writing on the paper surface. Note that, the cap surface preferably has a surface roughness Ra of 0.009 μm to 0.014 μm. If smoother than 0.009 μm, the cap is liable to slip on the paper surface, while if 0.014 μm or more, the paper surface is liable to be unintentionally scratched. Further, by making the durometer hardness as defined by JIS K6253 D 35 to 90, it is possible to improve the rigidity of the cap as a whole while facilitating the generate of the heat of friction without scratching the paper surface.

Note that, when using the part which is covered by an elastic member as an erasing member, the erasing member is not fit at the end at the opposite side to the writing part of the writing instrument body as usually seen in a pencil with an eraser etc., so there is also the advantage that detachment of the erasing member and other trouble do not occur.

Further, in injection molding of the cap body 13, the entry point into the inside of the cavity of the mold, that is, the gate part, is placed not at the top part of the cap body 13, but at a side surface, for example, a position where even if the cap body is inclined by 45′, it will not abut against the writing surface or the paper surface, so it is possible to make the surface of the top part smooth in appearance. Further, when using the top apart as an erasing member, use becomes possible without the problem of a so-called gate mark scratching the paper surface.

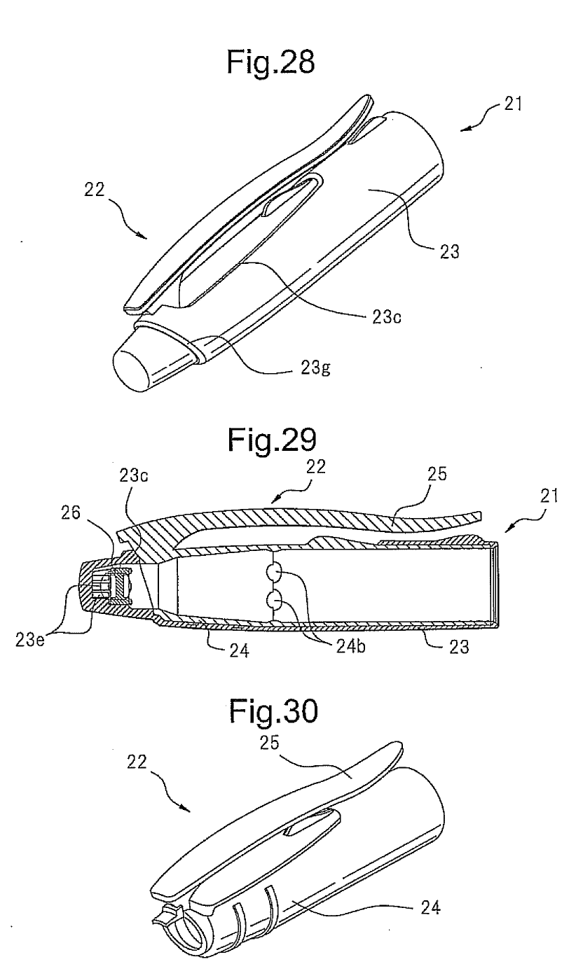

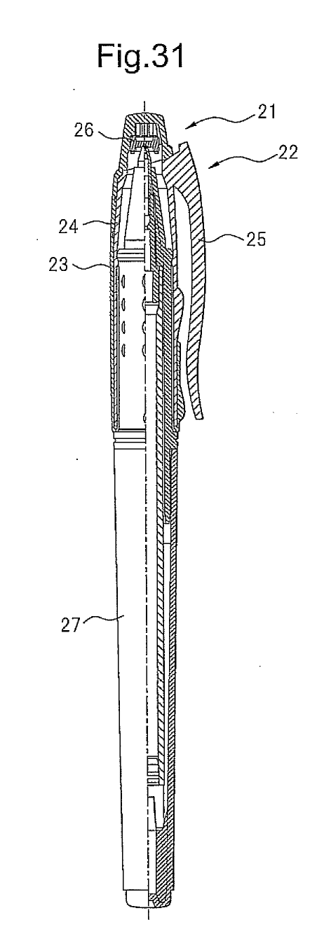

Next, the writing instrument-use cap according to still another embodiment will be explained. FIG. 28 is a perspective view of the writing instrument-use cap, FIG. 29 is a cross-sectional view of the writing instrument-use cap which is shown in FIG. 28, FIG. 30 is a perspective view of the clip member of the writing instrument-use cap which is shown in FIG. 28, and FIG. 31 is a cross-sectional view of the writing instrument as a whole to which the writing instrument-use cap which is shown in FIG. 28 is attached.

Reference numeral 21 shows the writing instrument-use cap as a whole, 22 the clip member, and 23 the cap body. In the following description, the points different from the writing instrument-use cap 11 according to the second embodiment will mainly be explained. The constitutions and effects not alluded to are similar to those of the second embodiment.

At the side surface of the cap body 23, for an aesthetic effect, a ring-shaped step 23g which is slanted with respect to the center axial line of the cap body 23 is provided.

The clip member 22 is comprised of a base part 24 and a grip part 25 which is integrally formed at the outer circumference of the base part 24. Note that, in the present embodiment, the base part 24 is formed in a ring shape. Below, this will be called a “ring-shaped part 24”.

The ring-shaped part 24 has a back side caliber which is larger than the front side caliber. In appearance, it forms a substantially tapered shape. It is formed so as to receive the front end of the writing instrument. The inside wall of the ring-shaped part 24 is formed into substantially cylindrical shapes by exactly predetermined lengths inward from the front end and from the back end. Between the regions which are formed by these cylindrical shapes, a tapered shape is formed. Further, the inside wall part of the cylindrical shape at the back side is provided, at equal intervals, with a plurality of guide projections 24b which project out along the longitudinal direction toward the center axial line. The features and effects of the guide projections 24b are similar to the guide projections 14b in the writing instrument-use cap 11 of the second embodiment, so explanations will be omitted.

The grip part 25 is configured to have enough elasticity to be able to be attached to a document, clothing, or other article together with the cap body 23.

As the material which forms the clip member 22, polycarbonate, acrylonitrile-butadiene-styrene or other plastic may be mentioned. However, to prevent the grip part 25 from breaking when bent etc., it may also be formed using an elastic material, in particular an elastic material the same was the cap body which is shown below.

The cap body 23 is a tubular member with one end closed and comprised of an elastic member for protecting the pen tip of the writing instrument. It is formed with an attachment hole 23c at its side surface. Inside of the cap body 23, the ring-shaped part 24 of the clip member 22 is arranged. The grip part 25 of the clip member 22 is provided so as to extend through the attachment hole 23c to the outside of the cap body 23. That is, the cap body 23 closes the opening at the front side of the ring-shaped part 24 of the clip member 22 and extends in a tubular shape from the opening of the back side by exactly a predetermined length to form an opening in which the writing instrument body is to be inserted. The attachment hole 23c is formed larger than the attachment hole 13c in the second embodiment. Part of the ring-shaped part 24 is exposed and an aesthetic effect is exhibited.

As the material which forms the cap body 23, silicone rubber, nitrile rubber, ethylene propylene rubber, ethylene propylene diene rubber, or another rubber material or a styrene-based elastomer, olefin-based elastomer, polyester-based elastomer, or other thermoplastic elastomer or such elastic material, a mixture of two or more elastic materials, and a mixture of an elastic material and a plastic may be mentioned.

The writing instrument-use cap 21 may have a rubber seal 26 and ribs 23e which hold it, but the features and effects of the rubber seal 26 and the ribs 23e are similar to the rubber seal 16 and the ribs 13e of the writing instrument-use cap 1 of the second embodiment, so the explanations will be omitted.

In the present embodiment, the base part 24 was formed into a ring shape, but it may be any shape which can reinforce the cap body, for example, it may be a shape which has a C-shaped horizontal cross-section. Further, regarding the fit of the writing instrument-use cap 21 with the writing instrument body in the present embodiment, a similar structure as with the second embodiment may be employed. However, the conventional known fitting structure such as shown in FIG. 31 may also be formed at the inner wall of the cap body 23 at the back end side from the ring-shaped part 24 of the clip member 22 in the longitudinal direction or the inner wall of the ring-shaped part 24 of the clip member 22.

Note that, only naturally, the ring-shaped part 24 of the clip member 22 of the writing instrument-use cap 21 in the present embodiment may also be structured having the flange part 15a at the open end such as shown in FIG. 24 to FIG. 26.

The present invention was explained in detail based on specific embodiments, but a person skilled in the art could make various changes, modifications, etc. without departing from the scope and idea of the present invention.

1. A writing instrument-use cap, comprising:
a tubular shaped cap body for protecting a pen tip, which cap body is comprised of an elastic member which is formed with an attachment hole in its side surface, and a clip member which has a base part and a grip part which is provided at an outside surface of said base part, and
wherein said clip member is provided with respect to said cap body so that said base part receives a front end of a writing instrument and said grip part extends through said attachment hole to the outside of said cap body.

2. A writing instrument-use cap, as set forth in claim 1, wherein:
said base part is formed in a ring shape.

3. A writing instrument-use cap, as set forth in claim 1, wherein:
an inside wall of said cap body toward the open end side from said base part in the longitudinal direction is provided with a stopping projection which fits with an engagement projection which is provided at the writing instrument body.

4. A writing instrument-use cap, as set forth in claim 3, wherein:
said base part is further provided with a back end face which abuts against a stopping face which is provided at the writing instrument body at the time of being fit together.

5. A writing instrument-use cap, as set forth in claim 1, wherein:
an outer surface of said writing instrument-use cap is formed with at least one through hole which communicates with the inside.

6. A writing instrument-use cap, as set forth in claim 1, further comprising:
a seal member which is held by an inner wall of a front end part of said cap body and which, when said writing instrument-use cap is attached over the writing instrument body, engages with a writing part at a front end of the writing instrument so as to seal the writing part.

7. A writing instrument-use cap, as set forth in claim 1, wherein:
a back end of said grip part is formed with a ball part, an outer circumference of said cap body is formed with a recess part which corresponds to said ball part, and said ball part and said recess part are arranged facing each other.

8. A writing instrument-use cap, as set forth in claim 1, wherein:
said cap body is injection molded using a mold which has a gate at a location other than one corresponding to the vicinity of the top part of the front end.

9. A writing instrument-use cap, comprising:
a tubular shaped cap body for protecting a pen tip, which cap body is comprised of an elastic member which is formed with an attachment hole in its side surface, and a clip member which has a first base part and second base part, at least one bridge part which connects said first base part and said second base part, and a grip part which is provided at an outside surface of said first base part, wherein said clip member is provided with respect to said cap body so that said first base part and said second base part receive a front end of a writing instrument and said grip part extends through said attachment hole to the outside of said cap body.

10. (canceled)

11. A writing instrument-use clip, which is suitable for forming a writing instrument-use cap which is provided with a tubular shaped cap body for protecting a pen tip, wherein:
said cap body is comprised of an elastic member which is formed with an attachment hole in its side surface, which writing instrument-use clip comprises a base part and a grip part which is provided at an outside surface of said base part, and is provided at said cap body so that said base part is housed inside of said cap body and receives a front end of a writing instrument and said grip part extends through said attachment hole to the outside of said cap body.

12. A writing instrument use-cap, according to claim 1, further comprising:
a writing instrument in operable combination therewith.

13. A writing instrument-use cap, comprising:
a tubular shaped cap body operable for protectively receiving an external pen tip of a writing instrument;
said cap body being an elastic member mid including an attachment hole along a side surface thereof;
a clip member having a base part and a grip part provided projecting at an outside surface of said base part;
said clip member operably secured with respect to said cap body and said base part operably retained in said cap body and arrayed for receiving said external pen tip of said writing instrument upon an insertion thereof; and
said grip part of said clip member extending along proximate an outside surface of said cap body.
